(19) United States
(12) Patent Application Publication
(10) Pub. No.: US 2022/0269105 A1
(43) Pub. Date: Aug. 25, 2022

(54) COMFORT ATTACHMENT ASSEMBLY FOR EYEWEAR

(71) Applicant: BRENT SHELDON, Miami Beach, FL (US)

(72) Inventors: BRENT SHELDON, Miami Beach, FL (US); Guy BROUSSEAU, Marieville (CA)

(21) Appl. No.: 17/629,542

(22) PCT Filed: Jul. 24, 2020
(86) PCT No.: PCT/CA2020/051027

§ 371 Date: Jan. 24, 2022

Related U.S. Application Data
(60) Provisional application No. 62/878,618, filed on Jul. 25, 2019.

(51) Int. Cl. G02C 5/06; G02C 5/12

(52) U.S. Cl. CPC G02C 5/06; G02C 5/122; G02C 11/12

(57) ABSTRACT

There is provided an assembly sized to fit over the lens of a pair of metal eyeglasses wherein the assembly is composed of one rigid material and one flexible material. The assembly is installed over a pair of existing eyeglasses to enhance comfort. The assembly also provides an adjustable nose pad that is composed of a rubber and creates a comfortable brow bar for the forehead of the wearer such that no rigid metal frame parts impinge upon the wearer.

### CROSS-REFERENCE TO RELATED APPLICATIONS

The present application is a continuation of PCT Application No. PCT/CA2020/051027 filed Jul. 24, 2020, which claims priority from U.S. Provisional Application No. 62/878,618 filed Jul. 25, 2019, the contents of both incorporated herein by reference in their entireties.

### TECHNICAL FIELD

The following relates generally to eyewear assemblies and methods of manufacturing eyewear assemblies. More specifically, the following relates to a comfort enhancing attachment assembly for eyewear.

### BACKGROUND

Conventional eyewear, particularly prescription eyeglasses, may be required by a user at all or most times to improve their vision. Eyeglasses generally include a frame that supports one or more lenses. The frame typically includes a nose bridge or nose pieces that engage the user's nose to support the eyeglasses on the user's head. Eyeglasses also typically include a pair of arms attached to (or integral with) the frame, to further support the eyeglasses, e.g. by resting the arms on the user's ears or engaging their head in the temple region.

One problem with conventional eyewear can arise when the eyewear frames are constructed from a hard material such as metal. This can cause discomfort to the wearer as the cold, hard, metal may impinge upon a wearer's face, especially around the nose bridge, temple and brow regions.

Moreover, although frames constructed from softer materials such as plastic may be more comfortable for the wearer, they may not be as durable as metal frames. Thus, metal eyewear that is durable, yet comfortable to wear can be difficult to find.

In certain instances, the eyewear may be missing nose pads or have damaged nose pads which cause the eyewear to repeatedly slip off the face. Currently the options for replacing or adding external nose pads to existing glasses can be limited.

It is an object of the following to address at least one of the above-noted disadvantages.

### SUMMARY

In one aspect, there is provided an attachment assembly sized to fit over a portion of a frame of a pair of metal eyeglasses wherein the assembly is composed of a first rigid material and a second flexible material. The assembly can be installed over a pair of existing eyeglasses to enhance comfort or be provided with new eyewear. The assembly also provides an adjustable nose pad that is composed of a soft material, such as rubber, to inhibit the impingement of rigid metal frame portions upon the wearer. In another aspect, an adjustable fit-over brow bar assembly and nose pad, is provided.

Another aspect pertains to an attachment assembly for eyewear comprising a support frame configured for coupling to the frame of eyewear and a flexible portion coupled to said support frame. The support frame comprises a top support having two brow portions coupled by a bridge portion located intermediately between said two brow portions. The flexible portion has a brow bar extending rearwardly from said top support of the support frame. The support frame is formed of a rigid material and the flexible portion is made from a compressible material.

In a further aspect, the brow bar is shaped to generally conform to the shape of a user's brow region.

In yet a further aspect, the rigid material has a Shore D durometer in the range of 10 to 100.

In yet a further aspect, the rigid material is a material chosen from the group consisting of polycarbonate (PC), polyvinyl chloride (PVC), polystyrene (PS), polypropylene (PP), polyethylene (PE) and acrylonitrile butadiene styrene (ABS).

In yet a further aspect, the compressible material has a Shore 00 durometer in the range of 10 to 90.

In yet a further aspect, the compressible material is a material chosen from the group consisting of rubbers, silicones, elastomers, thermoplastic elastomers, and polyurethanes.

In yet a further aspect, the support frame has a Shore D durometer in the range of 10 to 100 and said flexible portion has a Shore 00 durometer in the range of 10 to 90.

In yet a further aspect, the support frame further comprises a pair of nose pad supports downwardly extending from the bridge portion, each supporting a nose pad formed from the compressible material.

In yet a further aspect, the nose pad supports and nose pads are separate from said top support and brow bar.

In yet a further aspect, the nose pad supports and nose pads are formed together with said top support and brow bar.

In yet a further aspect, the top support includes a receiving channel on the bottom side thereof for receiving a top edge of an eyewear frame.

In yet a further aspect, the two brow portions are generally shaped such that when engaged with an eyewear frame a first leg extends downwardly on a rear side of the eyewear frame and a second leg would extend forwardly on top of the eyewear frame. The top support further comprising two anterior portions located on a lateral end of each of the brow portions and extending downwardly to engage a front side of the eyewear frame.

In yet a further aspect, the bridge portion and the brow portions of the support frame are monolithically formed.

In yet a further aspect, the bridge portion, the brow portions and the nose pad supports are monolithically formed.

In yet a further aspect, the nose pads are comprised of the rigid material and the flexible material; and wherein only the flexible material is in physical contact with the wearer.

In yet a further aspect, the nose pads are adjustable.

### BRIEF DESCRIPTION OF THE DRAWINGS

Embodiments will now be described with reference to the appended drawings wherein:

FIG. 1 is a front right perspective view of an attachment assembly fitted over an upper portion of an eyewear frame.

FIG. 2 is a right rear perspective view of the assembly of FIG. 1.

FIG. 3 is a left rear perspective view of the assembly of FIG. 1.

FIG. 4 is an exploded front perspective view of the assembly of FIG. 1.

FIG. 5 is an alternative exploded front perspective view of the assembly of FIG. 4.

FIG. 6 is a cross-sectional perspective view of a bridge portion of the assembly of FIG. 1, taken along line A-A.

FIG. 7 is a cross-sectional perspective view of a lens of the eyewear shown in FIG. 1, taken along line B-B.

FIG. 8 is a partial perspective view of the shield of the assembly of FIG. 1.

FIG. 9 is a right rear perspective view of the assembly of FIG. 1.

FIG. 10 is an exploded front perspective view of an alternative assembly.

FIG. 11 is a front right perspective view of yet another attachment assembly fitted over an upper portion of an eyewear frame.

FIG. 12 is a cross-sectional perspective view of a bridge portion of the assembly of FIG. 11, taken along line C-C.

FIG. 13 is a zoomed in view of the bridge portion of the assembly of FIG. 12.

FIG. 14 is a partial perspective view of the shield of the assembly of FIG. 12.

FIG. 15 is a zoomed in view of the shield of the assembly of FIG. 14.

### DETAILED DESCRIPTION

In order to enhance comfort and fit of eyeglass, particularly metal or other relatively rigid eyewear, an assembly can be attached to an upper portion of the frame (also referred to herein as the “brow bar”). The assembly is preferably constructed from two materials to increase the wearer's comfort while maintaining durability.

Such an assembly could provide softer nose pads and/or a softer brow assembly to enhance the comfort of eyewear, including but not limited to metal frame eyeglasses.

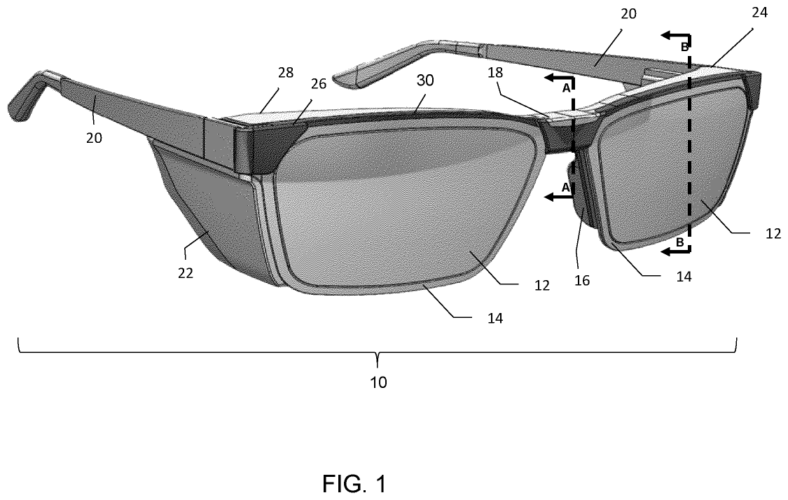

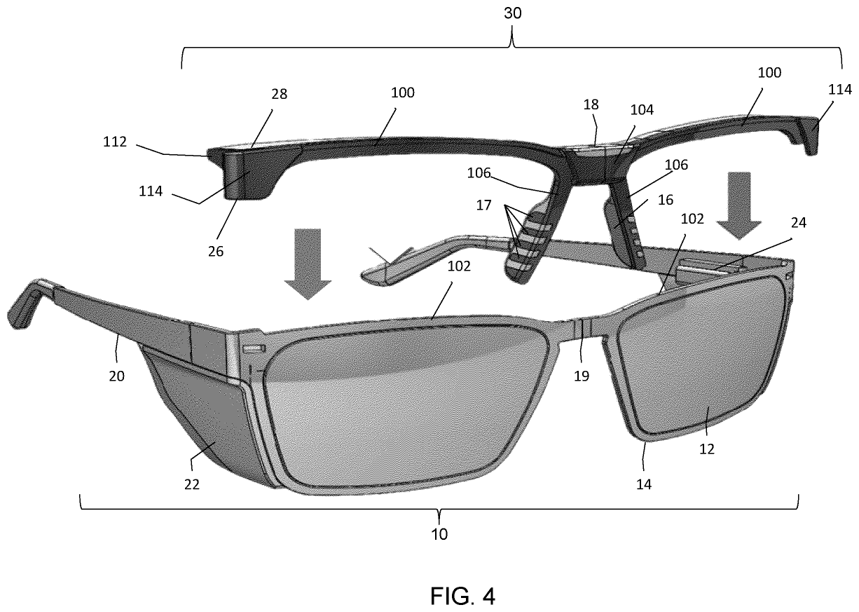

FIG. 1 illustrates a front perspective view of an eyeglass assembly 30 fitted on an eyewear frame 10. The frame 10 typically comprises a pair of arms 20, a bridge portion 19 (shown in FIG. 4), and a pair of lenses 12 supported within a pair of corresponding lens retainers 14. The eyewear frame 10 can optionally comprise side shields 22 for protecting against debris, light and impacts experienced by the wearer.

The assembly 30 can be used to upgrade or retrofit existing eyewear 10 or provided as a feature in combination with an eyeglass frame 10. The preferred assembly 30, depicted in the figures includes soft or compressible nose pads 16 and a soft or compressible brow bar. While the assembly depicted in the figures includes a brow portion and a nose portion, it should be noted that the assembly could be adapted to include only a brow portion, or a brow portion and separate nose portion.

Referring to FIG. 4, the assembly 30 comprises a support frame 26 having two brow supports 100 configured to couple to the brow portion 102 of the lens retainers 14 of the frame 10. The brow supports 100 are coupled at an interior end thereof to each other by a bridge support 104. In the preferred embodiment, nose pad supports 106 extend downwardly from opposite sides of the bridge support 104. Extending rearwardly from the later ends of the brow supports 100 are support legs 112. These support legs provide support against rotation of the assembly relative the frame by contacting a portion of each arm forward of the arm hinge. These support legs 112 further provide a surface for coupling the lateral edges of a brow section 108 of a flexible portion 28, discussed below. In a preferred embodiment, the Support frame can further include an anterior support 114 on the anterior, lateral portion of the brow support 100. This anterior support 114 engages or lies immediately adjacent the anterior portion of the frame 10 to provide further securement of the assembly 30 to the frame 10. The inclusion of this anterior support 114 can allow for only a partial channel in the brow supports 100. The partial channel includes a rear wall and a top wall, while the anterior wall is optional.

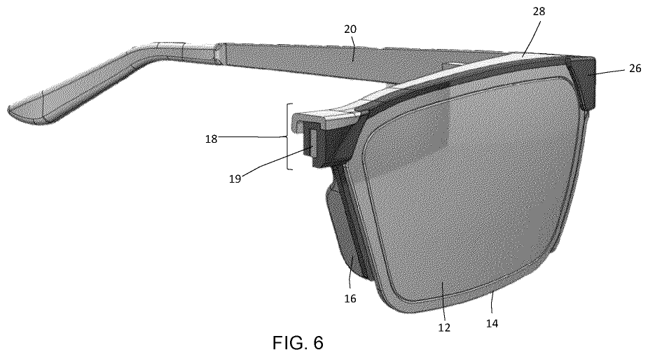

The support frame 26 of the assembly 30 is formed with a groove, slot, or other recessed portion, preferably on an underside thereof, which is sized to receive the brow portion 102 of the lens retainers 14. Furthermore, in a preferred embodiment the bridge support 104 also includes a slot in the bottom thereof (shown in FIG. 6) to fit over or engage the bridge 19 of the frame 10. In this preferred embodiment shown in FIG. 6, The assembly 30 can be placed over the top of the lens retainer 14 such that the brow portions 102 of the lens retainer fits directly in the slot in the brow supports 100 of the support frame 26. As depicted in the cross-sectional view of FIG. 6, the bridge portion 18 of the brow bar 30 may comprise a “J” type hook which can be snapped over the bridge portion 19 of the frame 10.

The assembly 30 can be permanently adhered to frame 10 using adhesive or other fastening mechanisms. Alternatively, the assembly 30 can be detachably removable from the frame 10 using screws, clips, frictional engagement, or magnets and the like. In a preferred embodiment, the top of the lens retainer 14 can be thin and narrow to help facilitate the assembly 30.

The assembly 30 further includes a relatively soft, flexible, compressible or deformable portion 28 (herein after referred to as the flexible portion) extending rearwardly from the support frame 26 toward the side of the wearer. This flexible portion 28 is coupled or fixed to the support frame 26, the details of which will be discussed below.

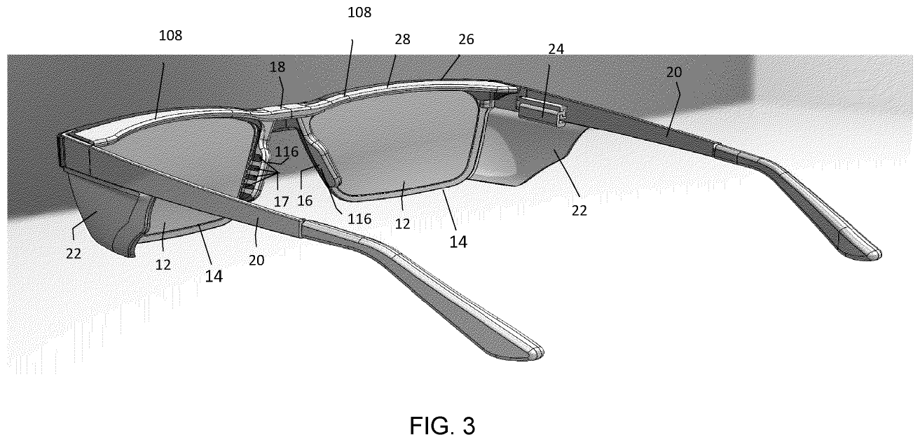

Referring to FIG. 3, the flexible portion 28 includes a two brow sections 108, located over each lens, and a bridge section 18 located between the two brow sections. The bridge section 18 is located over the bridge support 104 of the support frame 26. Together, the two brow sections 108 and the bridge section 18 located therebetween, preferably create a generally continuous brow cushion extending generally across the width between the arms 20 of the frame 10. In a preferred embodiment, the brow sections 108 are configured with a inward curve to generally conform to a user's brow. In one embodiment, the profile of the brow section 108 further includes a short straight section extending inwardly from the lateral-most edge to accommodate the fact that the face curves rearwardly at his portion of the profile and it must extend further in the rearward direction to maintain superior protection from particles entering as this part of the brow profile. When in use, the brow cushion would be in contact with, or in close proximity to, the wearers forehead and would generally prevent dust or other matter from entering the space between the lenses 12 and the wearers face. Furthermore, the flexible portion 28 acts as an impact absorbing material. If the wearer were to receive an impact to the eyewear, the soft portion would prohibit the support frame 26 and the frame 10 from touching the face. The soft portion 28 comprises a curved portion 32 which acts as a bumper, protecting the wearer from impact and increasing comfort of the eyewear.

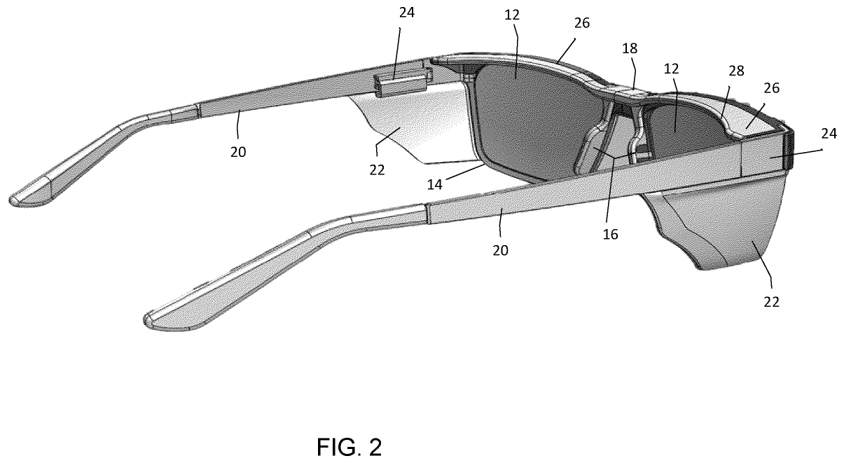

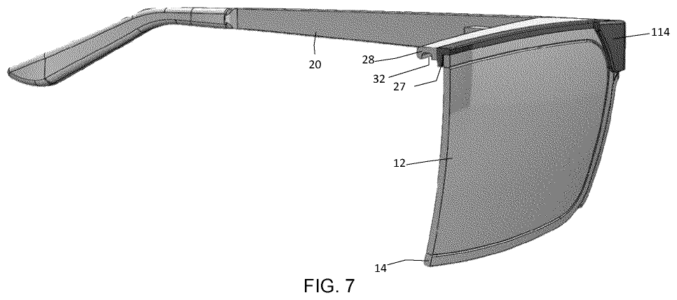

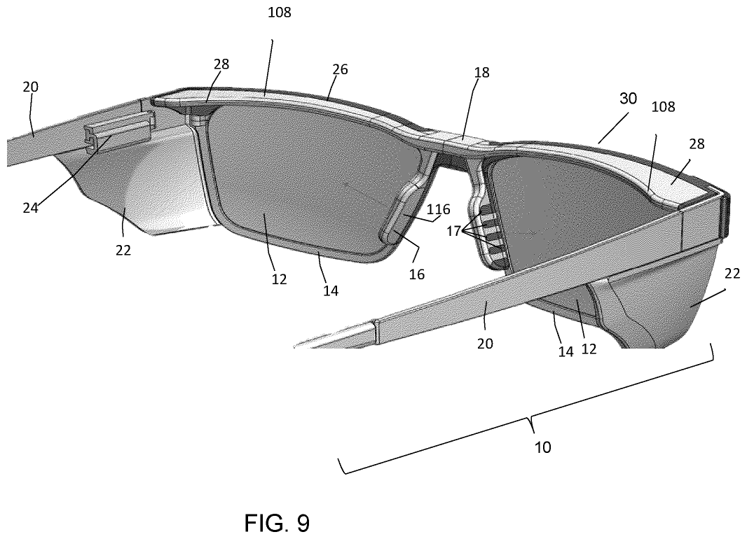

In an embodiment which includes nose pads, the flexible portion 28 further includes a pair of downwardly extended nose pad sections 116 which are supported by the nose pad supports 106. The nose pads, including both the nose pad support 106 and the flexible nose pad section 116 are refereed to collectively with reference character 16. These nose pads 16 are constructed with both the soft material of the flexible portion 28 and the more rigid material of the support frame 26 to increase the overall comfort of the nose pads 16 while providing some rigidity and flexibility through the use of a portion of the rigid material. In the preferred embodiment shown in FIGS. 1 to 9, the nose pad supports may additionally utilize fingers or prongs 17 extending rearwardly from the support frame 26. The prongs 17 may help the flexible material of the flexible portion 28 adhere more effectively to the support frame 26 due to the increased surface area created by the prongs 17. The prongs 17 may also create rigidity within the nose pads 16, preventing slipping. In an embodiment that includes nose pads, the assembly 30 may be assembled over a pair of eyewear 10 which does not have nose pads or, has damaged nose pads such that nose pads 16 can be easily added to any existing pair of eyeglasses.

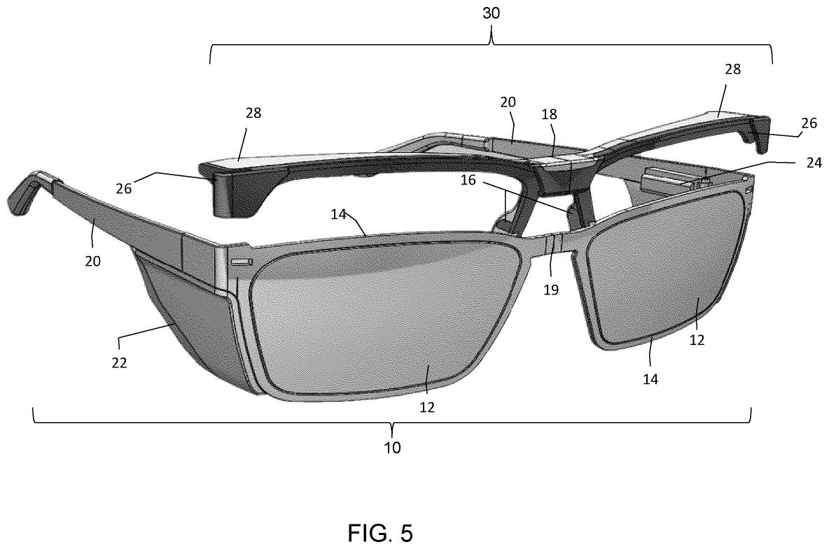

FIG. 5 illustrates an alternative exploded front perspective view of the assembly. It can be appreciated that the nose pads 16 are angled inwardly such that they can fit behind the lens 12 and lens retainer 14. As can be appreciated by a person skilled in the art, the nose pads 16 could be adapted to be adjustable in position relative to the bridge and frame 10. In one embodiment, the nose pads 16 can be deflected outward or compressed inward to ensure a more comfortable fit for the wearer and making them adjustable to the user. In yet a further embodiment, the nose pads 16 can also be detachable from the rest of the assembly 30 to allow for replaceable nose pads 16. This allows not only damaged nose pads 16 to be replaced, but also to permit different styles, shapes, or sizes of nose pads 16 to be accommodated.

As mentioned above, for eyewear having existing nose pads, the assembly can be created without a nose pad component. While the nose pads 16 are shown to be integral with the brow portion of the assembly, it can be appreciated that the brow portion and nose pads could be separate components.

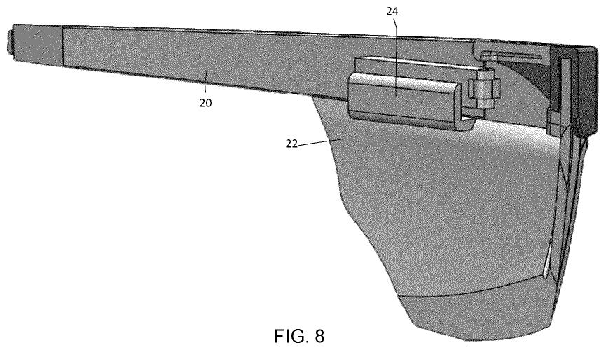

FIG. 8 illustrates a partial perspective view of the optional shield of the assembly of FIG. 1. The arm 20 of the eyewear comprises a temple assembly 24 which can be used to affix a side shield 22 to the eyewear. The side shield can be composed of plastic, metal or another material. A transparent plastic such as Acrylic or PMMA is preferable so the viewing capabilities of the eyewear is not hindered by the side shields 22. The side shields can be mounted one on each arm, only on one side, or on neither of the sides.

In a preferred embodiment, the soft portion 28 is over-molded onto the support frame 26, creating a sturdy, yet comfortable assembly 30 that fits over the brow bar of the frame 10 or otherwise provides a brow bar or enhances what may be referred to as the brow bar of the frame 10. Overmolding, sometimes referred to as two times injection molding, is a process where a single part is created using two or more different materials in combination. Typically, the first material (or substrate) is partially or fully covered by overmolded material during the manufacturing process. In this case, the support frame 26 acts as the substrate that is overmolded with the soft material 28, which is generally a softer plastic, rubber, or elastomer (e.g., PTE), or other suitable material. In an embodiment with nose pads, the outer, flexible material of the nose pads 16 can be overmolded onto the inner prongs 17 of the preferred embodiment which extend from the support frame 26. It can be appreciated that the overmolding steps may take place prior to or after the support frame 26 is affixed to the lens retainer 14.

A person skilled in the art would appreciate that there are many ways to couple the flexible portion 28 to the support frame 26 of the assembly 30. For example, the two components could be adhered together using techniques including, but not limited to, the use of a suitable adhesive, mechanical fasteners, heat welding, or vibration welding.

In a preferred embodiment, the flexible portion 28 of the assembly 30 is made from compressible materials, such as, but not limited to, rubbers, silicones, or elastomers such as thermoplastic elastomers (TPE), polyurethanes, etc. It has been found that compressible materials (i.e. with a Shore 00 durometer of at least 10 to 90 are suitable). However, in a preferred embodiment, materials with a Shore 00 durometer between 20 to 80 provide superior comfort and shock absorption properties. The support frame 26 can be made from a relatively harder plastic such as Thermoplastic such as PC (polycarbonate), PVC (polyvinyl chloride), polystyrene, polypropylene, polyethylene, ABS (Acrylonitrile butadiene styrene) and the like. It has been found that materials with Shore D durometer between 10 and 100 have suitable rigidity. However, in a preferred embodiment, materials with Shore D durometer between 35 and 90 provide enough rigidity to support the flexible portion and maintain in contact with the frame 10 while allowing for enough flexibility to allow for some deformation of the support frame as the bridge support is cammed over the bridge of the frame.

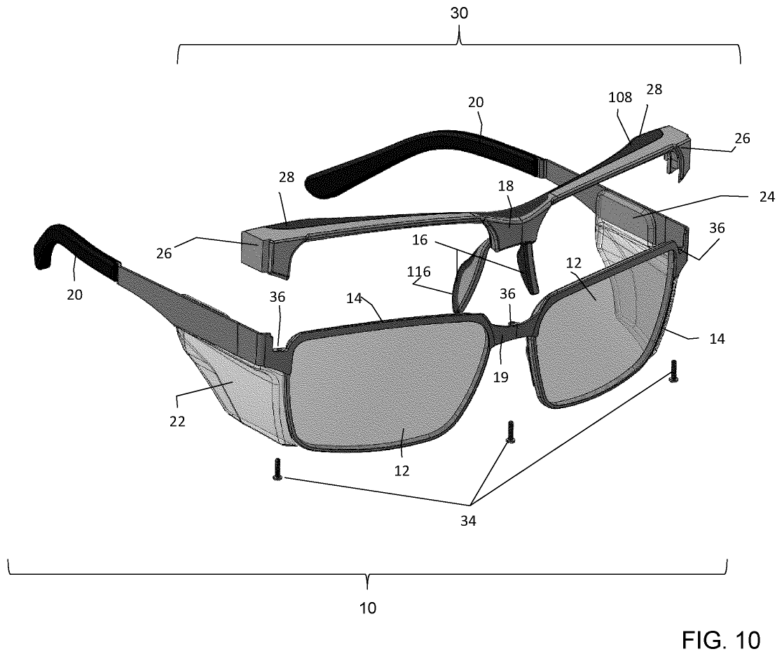

FIG. 10 is an exploded front perspective view of an alternative assembly. The assembly 30 can be fitted to the frame 10 using at least on screw 34 and at least one aperture 36 for receiving said screw 34. Preferably three screws are used, one screw on the bridge portion, and two near the temples of the eyewear. However, it can be appreciated that any number of screws can be used. The aperture(s) 36 for receiving the screw(s) 34 is/are preferably threaded.

FIG. 10 shows an alternative embodiment of the nose pads 16 of the assembly 30. In this embodiment, the nose pads 16 do not comprise prongs. Here, the nose pads 16 comprise a rigid portion consisting of the same rigid material of the support frame 26 and a soft portion consisting of the same soft material of the flexible portion 28. It can be appreciated that the assembly 30 does not require nose pads 16. In one instance, the nose pads can be detachable from the bride section 18. In another instance, the nose bride 18 does not comprise nose pads 16. This is particularly helpful when attaching assembly 30 to a frame 10 which has nose pads included.

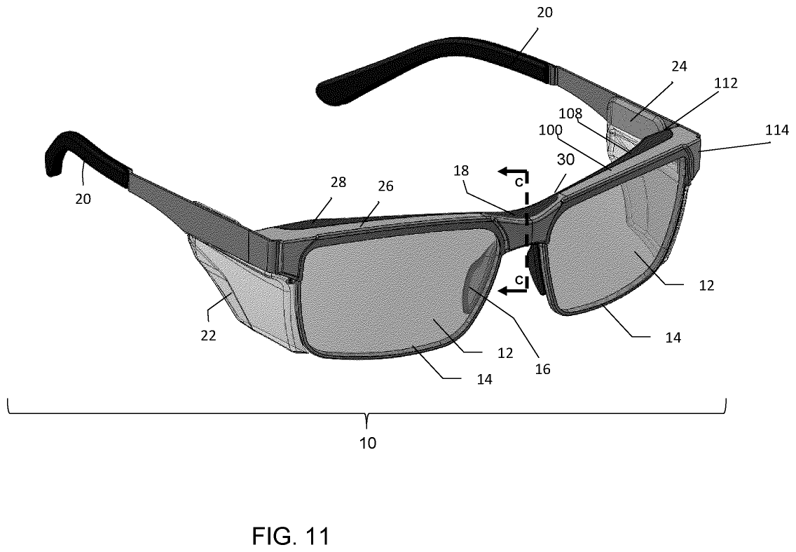

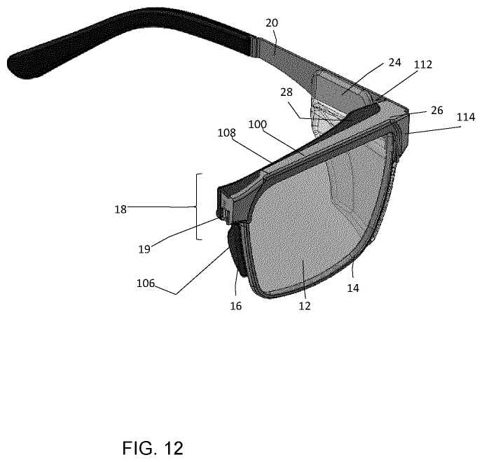

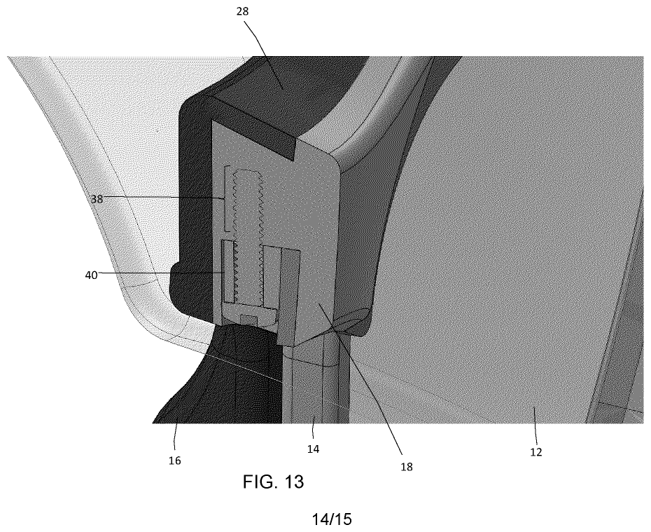

FIG. 11 is a front right perspective view of the alternative attachment assembly fitted over an upper portion of an eyewear frame. FIG. 12 is a cross-sectional perspective view of the bridge portion of the assembly of FIG. 11, taken along line C-C. FIG. 13 is a zoomed in view of the bridge portion of the assembly of FIG. 12. It can be appreciated that a saw-tooth attachment system 38, 40 can be used to join the frame 10 to the attachment assembly 30 at the nose portion as seen in FIG. 13. The saw tooth assembly is comprised of a receiving structure 40 in which the teeth 38 can be inserted into and held in place by the friction created between the teeth 38 and the receiving structure 40.

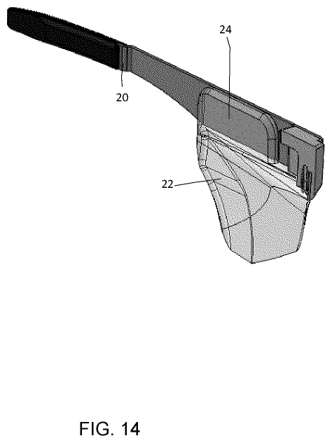

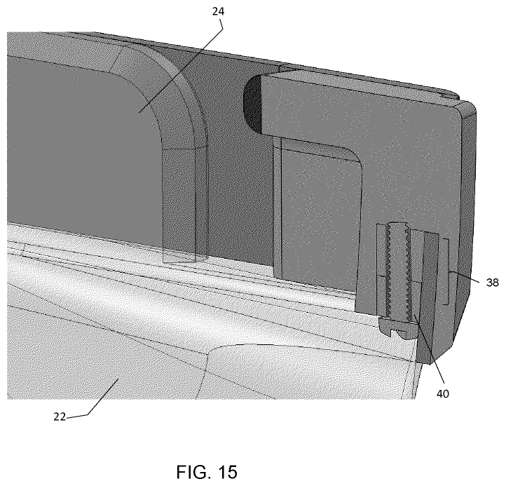

FIG. 15 is a zoomed in view of the shield of the assembly of FIG. 14. A sawtooth attachment system 38, 40 can also be used at the temples of the eyewear to join the frame 10 to the attachment assembly 30. This can provide further frictional engagement between the frame 10 and the attachment assembly 30. Preferably the attachment assembly 30 is affixed to the frame 10 using the saw-tooth attachment system 38, 40 at the temples of the eyewear and at the nose bridge portion. However, it can be appreciated that the saw-tooth attachment system 38, 40 can be located anywhere along the attachment assembly 30, and any number of attachment systems 38, 40 can be used.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. An attachment assembly for eyewear comprising:
a support frame configured for coupling to the frame of eyewear; and
a flexible portion coupled to said support frame;
said support frame comprising a top support comprising two brow portions coupled by a bridge portion located intermediately between said two brow portions;
said flexible portion having a brow bar extending rearwardly from said top support of the support frame; and
wherein the support frame is formed of a rigid material; and
wherein the flexible portion is made from a compressible material.

2. An attachment assembly as claimed in claim 1 wherein said brow bar is shaped to generally conform to the shape of a user's brow region.

3. An attachment assembly as claimed in claim 2 wherein said rigid material has a Shore D durometer in the range of 10 to 100.

4. An attachment assembly as claimed in claim 2 wherein said rigid material is a material chosen from the group consisting of polycarbonate (PC), polyvinyl chloride (PVC), polystyrene (PS), polypropylene (PP), polyethylene (PE) and acrylonitrile butadiene styrene (ABS).

5. An attachment assembly as claimed in claim 2 wherein said compressible material has a Shore 00 durometer in the range of 10 to 90.

6. An attachment assembly as claimed in claim 2 wherein said compressible material is a material chosen from the group consisting of rubbers, silicones, elastomers, thermoplastic elastomers, and polyurethanes.

7. An attachment assembly as claimed in claim 2 wherein said support frame has a Shore D durometer in the range of 10 to 100 and said flexible portion has a Shore 00 durometer in the range of 10 to 90.

8. An attachment assembly as claimed in claim 1 wherein said support frame further comprises a pair of nose pad supports downwardly extending from said bridge portion, each supporting a nose pad formed from said compressible material.

9. An attachment assembly as claimed in claim 2 wherein said nose pad supports and nose pads are separate from said top support and brow bar.

10. An attachment assembly as claimed in claim 2 wherein said nose pad supports and nose pads are formed together with said top support and brow bar.

11. The attachment assembly as claimed in claim 1 wherein said top support includes a receiving channel on the bottom side thereof for receiving a top edge of an eyewear frame.

12. The attachment assembly as claimed in claim 1 wherein said two brow portions are generally shaped such that when engaged with an eyewear frame a first leg extends downwardly on a rear side of said eyewear frame and a second leg would extend forwardly on top of the eyewear frame; said top support further comprising two anterior portions located on a lateral end of each of said brow portions and extending downwardly to engage a front side of the eyewear frame.

13. An attachment assembly as claimed in claim 1 wherein said bridge portion and said brow portions of said support frame are monolithically formed.

14. An attachment assembly as claimed in claim 4 wherein said bridge portion, said brow portions and said nose pad supports are monolithically formed.

15. The attachment assembly of claim 4, wherein the nose pads are comprised of the rigid material and the flexible material; and wherein only the flexible material is in physical contact with the wearer.

16. The attachment assembly of claim 15, wherein the nose pads are adjustable.
